(19) United States
(12) Patent Application Publication
(10) Pub. No.: US 2009/0319445 A1
(43) Pub. Date: Dec. 24, 2009

(54) Ching-Min Huang System

(76) Inventor: Ching-Min Huang, Yongkang City (TW)

Correspondence Address: CHING-MIN HUANG, 3F, NO. 5, ALLEY 47, LN. 76, JHONGSIAO RD.,, YONGKANG CITY, (R.O.C.), TAINAN COUNTY, 710, TW

(21) Appl. No.: 12/201,712

(22) Filed: Aug. 29, 2008

(51) Int. Cl. G06Q 90/00

(52) U.S. Cl. 705/500

(57) ABSTRACT

The proposed new political system, C.-M. Huang System, is according to the concept of separation of powers.

### BRIEF SUMMARY

This system is used to resolve the problems arising in political and judicial systems.

### BACKGROUND

Based on the principle of the separation of powers, that is, the executive, the legislative and the judicial powers, put forward by French political thinker Baron de Montesquieu (1689-1755) in his book De l'esprit des lois (1748), this system consists of three branches: the Executive Government, the Legislature and the Judicature, which respectively comprise the executive, legislative and judicial powers. These three form an integrated system which functions to ensure that the influence of any one power cannot exceed that of the other two, either singly or in combination. These powers should be separate from and dependent upon each other.

### DETAILED DESCRIPTION

### Chapter 1

### The Executive Government

### Article 1 (Position and Organization of the Executive Government)

The Executive Government is the highest administrative body of the Country. It has a Prime Minister, four Deputy Prime Ministers, chief and deputy chief officers of respective offices, and several policy commissioners.

The Prime Minister is the head of state, who deals with outsiders on behalf of the Country, and occupies the highest administrative position within the Country.

The Examination organ is in charge of organizing the following examinations to select qualified public officials for the Country:
1. The national civil officer examination
2. The national military officer examination
3. The national registration examination

The first two examinations are used to select public officials while the third examination is conducted to recruit tentative public officials under emergency orders.

The Executive Government is equipped with national armed forces to safeguard the Country.

Those who are in active duty for the national armed forces are not allowed to be involved in any activities held by political parties, and shall remain neutral in politics.

The national civil officer examination, military officer examination and registration examination shall be instituted by law.

The source and protection of national armed forces, as well as the control of weapons, shall be instituted by law.

Establishment and revocation of local regions, and division and adjustment of administrative zones shall be instituted by law.

The organization of local governments and their legislative bodies shall be instituted by law.

The organization of the Executive Government shall be instituted by law.

### Article 2 (Election and Term of the Prime Minister)

The Prime Minister shall be elected in a national election, and the term is four years. The term can be renewed once in case of being re-elected. The election shall be held within three months of the expiration of each term.

By-election shall be held within two months, and the elected Prime Minister shall succeed to the office within seven days after the confirmation of election results. The term shall last until the expiry of the original term.

The Prime Minister shall be discharged from office and make resignation announcement from the cabinet on the expiry date of the term.

In the event that the next Prime Minister has yet to be elected after the discharge of the current Prime Minister, the current Prime Minister shall act on the next Prime Minister's behalf and the original cabinet deployment shall remain until the next Prime Minister's election.

The election of Prime Minister shall be instituted by law.

### Article 3 (Prime Minister)

The Prime Minister is head of the nation-wide armed forces and decrees military orders by law.

The Prime Minister appoints or removes cabinet officers and civil and military officers by law.

The Prime Minister announces laws and decrees administrative orders by law. The Prime Minister confers honors by law.

The Prime Minister exercises the right to grant general amnesty, special amnesty, sentence reduction and reinstatement by law.

The Prime Minister exercises the right to sign treaties, declare war and make peace by law.

While exercising above mentioned rights, the Prime Minister shall comply with the following stipulations:
1. Excepting for situations involving the appointment or dismissal of the Deputy Prime Ministers applied in the first and second items below, documents shall be co-signed by a Deputy Prime Minister under a different party to that of the Prime Minister, and the enforcement shall be conducted within 12 days after receipt of the co-signed document.
2. Item 1, as stipulated below:
   Without signing treaties and declaring war, the Prime Minister is not allowed to deploy national armed forces beyond the range of people's rights regulated in the Rights Act.
   In the event that the Country enters civil war or declares war, the Prime Minister shall instruct the chief officer of the defense organ to command the Chief of the General Staff to direct the war.
   In case of attack from outside during the military patrol period, a counterattack shall be initiated immediately without waiting for any military order.
3. Item 2, as stipulated below:
   Depending on whether it supports the policy espoused by the Prime Minister's political party or not, a political party may ally with the Prime Minister's political party or other political parties. In this regard, political parties can be divided into Prime Minister Parties and non-Prime Minister Parties.
   In cases where the number of legislators in Prime Minister Parties or non-Prime Minister Parties is more than ⅔ of the total, the negotiation shall be processed in accordance with the Partisan Act.
   For Prime Minister Parties, the bi-partisan negotiation shall be led by the Prime Minister.
   For non-Prime Minister Parties, the bi-partisan negotiation shall be dominated by the Deputy Prime Minister of non-Prime Minister Parties.
   Deputy Prime Ministers, chief officers and deputy chief officers of respective organs and policy commissioner shall be appointed as agreed by the Legislature after being recommended by the political parties winning more than 5% of ballots in the Prime Minister Election and nominated by the Prime Minister, and whose term shall be terminated with the Prime Minister's cabinet resignation.
   The vacancies of the foresaid cabinet officers shall be nominated by the Prime Minister within seven days, and appointed as agreed by the Legislature.
   Deputy Prime Ministers, chief officers and deputy chief officers of respective organs shall take full political responsibility for policy failure no matter what parties they belong to, announce the policy failure during the implementation period, and terminate the policy budget.
   Chief officers and deputy chief officers or civil and military officers of government organs shall simultaneously include those under Prime Minister Parties and the ones under non-Prime Minister Parties.
4. Item 3, as stipulated below:
   Except for the Order of Martial Law and Emergency Order which are special administrative decrees, other administrative decrees are exempt from the examination of the Legislature.
   The co-signature of administrative decrees may be authorized by policy authorization, stage authorization, deadline setting or oral commitment.
5. Item 4, as stipulated below:
   Nomination of recipients of diplomatic honors is made by the diplomatic organ.
   A quota of the awards of national honors shall be respectively distributed to the organs and their personnel administration agencies under the Executive Government, the Legislature, and the Judicature. The honors shall be given through nomination made through internal election in respective organs and evaluation by personnel administration agencies, in which, except for the Prime Minister, Deputy Prime Ministers, President and Vice President of the Legislature and Grand Justices, all other personnel are eligible for being elected.
   The civil association recipients of the honors shall be nominated by the organs respectively under the Executive Government, the Legislature and the Judicature.
6. Item 5, as stipulated below:
   General amnesty may be given for the case requiring judicial relief or worth forbearance given that there are too many violators and the forgiveness can be justified.
   Special amnesty may be given to one or a number of perpetrators whose motives for the crime are forgivable or receiving non-guilty verdict after retrial for wrongful imprisonment.
   When prisons are crowded and the Country has no intention to build new prisons or increase relevant judicial budget, a national sentence reduction can be applied to prisoners.
   Individual sentence reduction can be given in the case that a prisoner has good performance in prison, or due to a legal loophole and assists in judicial investigation.
   The Country can consider restoring the rights of those who are deprived of citizen rights and giving them a chance to take up work as a constitutional public official or general public official; or reinstating those who receive non-guilty verdict after retrial for wrongful imprisonment.
7. Item 6, as stipulated below:
   The treaties involving rapprochement, alliance or cooperation can be signed.
   In the event that another country takes initiative in declaring war against the Country, or the Country becomes hostile to another country and resorts to force, the Country may declare war.
   When the Country accepts the mediation from the country initiating the war, or a third country for truce, or the Country is in an inferior position after declaring war and has no intention to continue the war, the Country may make peace.

In the situation that the position of Deputy Prime Minister of non-Prime Minister Parties is vacant and the County encounters severe calamity requiring emergency attendance, the Prime Minister may be temporarily free from the foresaid co-signature restriction after receiving the adjudication of the Grand Justices Council.

The Prime Minister shall take full political responsibility for the nation's overall policy, and may proclaim policy failure during the enforcement period and terminate the policy budget. In order to fulfill national policies, the Prime Minister may periodically hold the following councils by law:
1. The Executive Government Council
2. The Financial and Economic Council
3. The National Construction Council
4. The National Security Council
5. The Crime Prevention Council

Provisional meetings, in addition to the preceding councils, may be held as needed. Also, relevant cabinet officers shall be summoned for extraordinary meetings when national administrative guidelines require modification.

The Prime Minister may request the Legislature to hold provisional meetings in recess.

The Prime Minister has constitutional immunity, so except for offenses against internal and external securities and the crimes added in the adjudication of the Grand Justices Council, the Prime Minister is exempt from the prosecution of constitutional punishment unless resignation or dismissal.

### Article 4 (Deputy Prime Ministers)

Within the authority given by the Prime Minister, the Deputy Prime Ministers may decree administrative orders by law, in which co-signature from the Prime Minister is required. Any behavior overstepping the delegated authority is referred to as ultra vires. For the Deputy Prime Ministers under Prime Minister Parties, apart from the co-signature of the Prime Minister, the co-signature from the Deputy Prime Minister of non-Prime Minister Parties is also required.

The co-signature required by the foresaid Deputy Prime Ministers in exercising their authority may follow the co-signature model used by the Prime Minister.

The First Deputy Prime Minister shall be from a Prime Minister Party, and succeed the Prime Minister when the position of Prime Minister is vacant or the Prime Minister is incapable of attending business.

When the foresaid First Deputy Prime Minister does not succeed or the position becomes vacant after succession, the next Deputy Prime Minister shall succeed as the Acting Prime Minister, and hold by-elections to elect a new Prime Minister. The Acting Deputy Prime Minister will remain in seat until election of the new Prime Minister. At that time, the Acting Prime Minister shall withdraw from such temporary position and proclaim the dissolution of all Deputy Prime Ministers.

In the event that the positions of Prime Minister and Deputy Prime Ministers are vacant, the position of the Acting Prime Minister shall be taken, in this order of precedence, by the Presidents of the Legislature and Judicature, the chief officer and deputy chief officer of the defense organ, and the Chief of the General Staff. At the same time, by-election shall be held. After the succession of the Acting Prime Minister, the Acting Prime Minister shall withdraw from the position on the new Prime Minister's inauguration date.

When the First Deputy Prime Minister occupies the position of Acting Prime Minister, the First Deputy Prime Minister shall proclaim cabinet dissolution and dismiss the Legislature, while holding a by-election of the Prime Minister and legislators in order to use new public opinions as the basis for modifying the Country's administrative guidelines. The highest ranking civil and military officers of the respective organs, having temporarily taken over as chief officers or deputy chief officers of respective organs, shall withdraw from the acting positions on the arrival of the new chief officers and deputy chief officers of respective organs.

In the event that the Country encounters acts of God, plagues, grave financial turbulence, internal riots or external intrusion prior to the new Prime Minister and legislators being elected, the resigning Prime Minister, cabinet officers and legislators shall be automatically reinstated until the reason for reinstatement disappears. By then, the Prime Minister shall proclaim the termination of the post, and a by-election of the new Prime Minister and legislators shall be held. In cases where the reason for reinstatement has not disappeared but the original term has expired, a by-election of the new Prime Minister and legislators shall be held and the expired Prime Minister and legislators shall be dismissed from their posts on the arrival of the new Prime Minister and legislators.

The First Deputy Prime Minister shall act temporarily for the Prime Minister when the Prime Minister departs from the Country for a substantial period of time, or the Prime Minister is under suspension from post. The acting position shall be terminated upon the Prime Minister's return to the Country or reinstatement.

Prior to the return or reinstatement of the foresaid Prime Minister, if the position of the First Deputy Prime Minister is vacant, the position of the Acting Prime Minister shall be taken, in this order of precedence, by the next Deputy Prime Minister, and the Presidents of the Legislature and Judicature, until the Prime Minister returns to the Country or is reinstated.

### Article 5 (The Policy Council)

The Policy Council, judging officers, the Policy Council Deputies and several partisan policy commissioners in the Executive Government are entitled to resolve added national policies and reconsider general legal cases, budget cases and treaty cases resolved in the Legislature. The Policy Council shall be attended by eight judging officers not belonging to any political party, one Policy Council Deputy and five commissioners from Prime Minister and non-Prime Minister Parties respectively. The Policy Council Deputy shall chair the procedures of the Council, and the policy commissioners shall debate the detail, basing their discussions on reason, while the judging officers shall resolve the issue with an open ballot by taking into account national interests, and policy feasibility and necessity. If more than half of the judging officers vote with Prime Minister Parties, the bill proposed by Prime Minister Parties shall be passed, or the bill proposed by non-Prime Minister Parties shall not be passed.

The judging officers may explain why the bill is or is not passed, and remove those stipulations of the passed bill which do not meet the requirements of the Country's interests or policy feasibility and necessity.

The Prime Minister shall include the policies of the non-Prime Minister Parties' which are passed in the Policy Council in national policies, and have relevant organs organize these before sending to the Legislature for examination.

In the event that the national budget is deficient for the fulfillment of the policy passed in the Policy Council, the Executive Government shall hold a meeting to determine if the policy shall be included in the national budget, the decision to be made according to the policy's importance and urgency.

Judging officers shall take political responsibility for policies which, having been passed when they ought not to have been or not having been passed when they ought to have been, operate to the detriment of the Country's interests.

Judging officers shall be independent of all political parties and, by law, decide policy independently. Also, when the data supporting the espousal of or opposition to a policy is insufficient, or it is necessary to verify the data, the judging officers may instruct the policy commissioners to complete the required data without any interference.

Unless being subject to constitutional punishment or an interdiction declaration, judging officers cannot be dismissed; or be suspended from duties, transferred or given salary deduction, unless otherwise stated in law.

The Policy Council Deputies shall be independent of all political parties and, by law, decide Policy Council procedure independently without any interference.

Unless being subject to constitutional punishment or an interdiction declaration, the Policy Council Deputies cannot be dismissed; or be suspended from duties, transferred or given salary deduction, unless otherwise stated in law.

Policy commissioners are entitled to propose policies which shall be submitted by the political party to which they belong. Civilians may bring a policy to a political party in order for policy commissioners to submit it for examination.

Except for criminals caught in the act, policy commissioners are not allowed to be arrested or detained during the policy examination period unless more than half of judging officers agree to it.

The judging officers, Policy Council Deputies and policy commissioners shall not be a concurrently serving national official.

The organization of the Policy Council and its council procedures shall be instituted by law.

### Article 6 (The Council of the Executive Government)

The Council of the Executive Government in the Executive Government consists of the Prime Minister, Deputy Prime Ministers, and chief and deputy chief officers of respective organs. The Prime Minister shall preside over the Council.

The Prime Minister, Deputy Prime Ministers, and chief and deputy chief officers of respective organs shall submit the constitutional bill, rights bill, litigation entity bill, Executive Government organization bill, local system bill, administrative official bill, general legal case, budget case, treaty case, general amnesty case, special amnesty case, sentence reduction case, reinstatement case, wrongful imprisonment case, honor awarding case, war declaration case, peacemaking case and other important cases or cases relating to collective relations amid respective organs, which shall be submitted to the Legislature, to the Council of the Executive Government for resolution.

The Executive Government shall nominate chief officers of National Medical Research Institute, National Scientific Research Institute, National Engineering Research Institute, National Military Research Institute and National Social Science Research Institute for the Legislature for approval and appointment. The term is six years and can be renewed once.

Academicians are placed in respective preceding research institutes to provide national education policies. Chief officers of those research institutes shall compile the opinions of the academicians and send these to the educational and human resources organ for joint evaluation and as a reference for formulating education policies and fulfilling projects.

The Executive Government shall nominate the general, lieutenant general, major general and brigadier general for the Legislature to approve and appoint.

The foresaid generals in the defense organ shall provide national military policies. The chief officers of relevant military agencies shall compiles the general officers' opinions and send these to the national defense organ and Military Research Institute as a reference for developing the national defense strategy and national combat strategy, conducting military research and development, formulating military policies, conducting evaluation and fulfilling projects.

The Executive Government shall nominate the Criminal Prosecutor General for the Legislature to approve and appoint. The term is six years and renewal is not allowed.

The Executive Government shall nominate the Police General for the Legislature to approve and appoint. The term is six years, and renewal is not allowed.

The Executive Government shall nominate the civil officer of the transferred Policy Council Deputies for the Legislature to approve and appoint. The term of six years, which shall be individually calculated regardless of the sequence of the year, does not admit of renewal. The appointed civil officer shall return to the original unit upon expiry of the term.

The Executive Government shall nominate the Grand Justices for the Legislature to approve and appoint. The term of eight years, individually calculated regardless the sequence of the year, does not admit of renewal.

In the event of a Grand Justice's office becoming vacant, the Prime Minister shall re-nominate a new Grand Justice within 7 days for the Legislature to approve and appoint.

The organization of the Council of the Executive Government and its council procedure shall be instituted by law.

### Article 7 (The Financial and Economic Council)

The Financial and Economic Council in the Executive Government is an advisory agency for the Prime Minister to handle financial, economic and banking affairs and severe national calamities. The Council shall be attended by the Prime Minister, Deputy Prime Ministers, chief officers and deputy chief officers of the financial organ, economic organ and respective affiliated organs and the relevant personnel designated by the Prime Minister and Deputy Prime Ministers. The Prime Minister shall preside over the Council.

In the event that the Country encounters acts of God, plagues, and grave financial turbulence requiring emergency attendance for the people's livelihood and economy, the Prime Minister may follow the resolution made in the Financial and Economic Council to proclaim an emergency order regulated in the Emergency Order Act as requisite disposition.

The order shall be submitted to the Legislature for confirmation within one month after the proclamation. In case of disapproval of the Legislature, the order shall be invalidated immediately.

The enforcement period of the order shall be no more than six months from the date of proclamation, but, pending agreement by the Legislature, the order period can be extended once.

By following the stipulation below, the Financial and Economic Council may set up national provision funds:
1. Financial organ's urgency provision fund
2. Economic organ's price stabilization fund
3. Agricultural organ's grains reserve fund
4. Health organ's medical relief fund
5. Central Bank's exchange stabilization fund

The use of national provision funds shall be instituted by law.

The organization of the Financial and Economic Council and its council procedure shall be instituted by law.

### Article 8 (The National Construction Council)

The National Construction Council in the Executive Government is an agency for the Prime Minister to control the planning, coordination, supervision of new national construction projects passed in the Policy Council, tracking of the progress of old national construction projects, implementation of budgets, and evaluation of performance. The Council shall be attended by the Prime Minister, Deputy Prime Ministers, chief and deputy chief officers of respective local governments, chief and deputy chief officers of the construction organ, transportation organ and respective affiliated organs and the relevant personnel designated by the Prime Minister and Deputy Prime Ministers. The Prime Minister shall preside over the Council.

The organization of the National Construction Council and its council procedure shall be instituted by law.

### Article 9 (The National Security Council)

The National Security Council in the Executive Government consists of a Secretary-General, a Deputy Secretary-General and several intelligence officers. It is in charge of the planning and execution of national security and intelligence, and special types of duty. It is also an advisory agency for the Prime Minister to handle national defense and diplomatic affairs and severe national calamities.

The National Security Council shall be attended by the Prime Minister, Deputy Prime Ministers, chief and deputy chief officers of the national defense organ, diplomatic organ, central intelligence organ, military intelligence organ and respective affiliated organs, and the relevant personnel designated by the Prime Minister and Deputy Prime Ministers. The Prime Minister shall preside over the Council.

In the event that the Country encounters external intrusion or internal riots requiring emergency attendance for national security, the Prime Minister may follow the resolution made in the National Security Council to proclaim an Order of Martial Law as requisite disposition.

The order shall be submitted to the Legislature for confirmation within one month of the proclamation. In case of the Legislature's disapproval, the order shall be invalidated immediately.

The Legislature may resolve to request the Prime Minister to lift Martial Law when it thinks necessary.

The organization of the National Security Council and its council procedure shall be instituted by law.

### Article 10 (The Crime Prevention Council)

The Crime Prevention Council in the Executive Government is an advisory agency for the Prime Minister to formulate social security policies. The Council shall be attended by the Prime Minister, Deputy Prime Ministers, chief and deputy chief officers of the internal affairs organ and justice affairs organ, the criminal prosecutor general, the criminal chief prosecutors, the police general, armed police officers, judicial police officers, chief officers of respective affiliated organs and the relevant personnel designated by the Prime Minister and Deputy Prime Ministers. The Prime Minister shall preside over the Council.

The organization of the Crime Prevention Council and its council procedure shall be instituted by law.

### Article 11 (Prime Minister's Responsibilities Towards the Legislature)

The Prime Minister shall be held accountable for the Legislature in accordance with the following stipulation:
1. The Executive Government has the responsibility to report its administrative policies and performance to the Legislature.
2. In the event that the Executive Government is impeded by the general legal, budget or treaty case resolved by the Legislature, it may request the Policy Council to give priority to the examination of the given case within seven days of the resolved case reaching the Executive Government. The resolution for this shall be made within 12 days of the request reaching the Policy Council. The resolution made by the Policy Council shall be sent to the Council of the Executive Government for review, modification and re-resolution within seven days. The resolution made by the Council of the Executive Government shall be sent to the Legislature for reconsideration. For the case sent up for reconsideration by the Executive Government, the Legislature shall come up with a resolution within 12 days of receiving the case. The original resolution will be invalidated if the resolution of the case under reconsideration is overdue in resolution. In cases in which more than half of all legislators uphold the original resolution in reconsideration, the Executive Government shall accept the decision.

### Article 12 (Budget and Final Accounts of the Executive Government)

The Executive Government shall bring the following year's general budget of Central Government before the Legislature three months prior to the start of the fiscal year. The rough yearly estimates of the Legislature and Judicature shall have priority in being included in Central Government's general budget, for which the Executive Government is not allowed to delete or curtail the budget, but may remark its opinions.

The Executive Government shall bring the general final accounts of Central Government before the Judicature within three months of the end of the fiscal year.

### Chapter 2

### The Legislature

Article 13 (Position, organization and Powers of the Legislature)

The Legislature is the highest legislative body of the Country. It consists of the legislators elected by the people. The legislators exercise legislative powers on behalf of the people.

The Legislature has the right of approval over the personnel nominated by the Executive Government and the Judicature, for which the resolution shall be made within seven days of receipt of the nomination. During the recess period, the Legislature shall hold a meeting on its own within three days and come up with a resolution within seven days of the start of the meeting.

The waiting list of the judging officers of the Policy Council, Policy Council Deputies and policy commissioners in the Executive Government shall be made available. In case of having vacancies or being in manpower deficiency, the Judicature or the Executive Government may make the selection from the candidates on the waiting list. The validity of the waiting list of the judging officers and Policy Council Deputy is six years.

The Legislature is entitled to resolve the constitutional case, rights bill, litigation entity bill, Executive Government organization bill, local system bill, administrative personnel bill, general legal case, budget case, treaty case, general amnesty case, special amnesty case, sentence reduction case, reinstatement case, wrongful imprisonment case, honor awarding case, war declaration case, peacemaking case, Martial Law order case, emergency order case, and other important national administrative cases.

The foresaid constitutional case or rights case shall be passed if given the approval of more than 7/10 of legislators. In the event that the rights bill is not passed but ⅗ of legislators approve it, a referendum shall be held within half a year of the announcement date in accordance with the Referendum Act.

The Legislature is entitled to resolve the litigation procedure bill, Judicature organization bill, court organization bill, judicial personnel bill, audit personnel bill and other items of national judicial importance submitted by the Judicature.

The Legislature is entitled to resolve the Legislature organization bill, legislative personnel bill and other items of national judicial importance submitted by the partisan caucuses in the Legislature.

The Legislature shall submit the proposal for the awards of honor, which shall be submitted to the Executive Government, to the Council of the Legislature for resolution.

With co-signatures from more than ⅓ of all legislators, the Legislature may put forth a no-confidence bill against the Prime Minister which shall be resolved in open ballot. In this case, if more than ⅗ of legislators approve it, the Prime Minister shall submit a resignation within three days. On the other hand, if the no-confidence bill is not passed, the Prime Minister will be free from any charges of no-confidence for the duration of one year.

With co-signature from more than ⅓ of all legislators, the Legislature may put forth a duty negligence charge against a Grand Justice which shall be resolved in open ballot. In this case, if more than 7/10 of legislators approve it, the Grand Justice shall submit a resignation within three days. On the other hand, if the duty negligence charge is not passed, the Grand Justice will be free from any duty negligence charges for the duration of two years.

An annual key note address shall be given by the Prime Minister at the Legislature's annual conference.

The Legislature is entitled to interpolate the Prime Minister, Deputy Prime Ministers, President of the Judicature, and chief and deputy chief officers of respective agencies in its conference.

Commissions of the Legislature may invite government officers and relevant members of society to come to the meeting for interpellation.

For budget cases submitted by the Executive Government, the Legislature shall not violate the following regulations:
1. Curtail the budget made up for the national provision fund.
2. Propose to add to the budget.

The council procedure of the commissions of the Legislature shall be instituted by law.

The council procedure of the Legislature shall be instituted by law.

The organization of the Legislature shall be instituted by law.

Article 14 (Election and Term of legislators)

There are a total of 152 legislators in the Legislature with a term of four years. The term can be renewed twice in case of re-election. The election shall be completed at least three months prior to the expiry of each term, and the regulations below shall be followed in election:
1. Election of 83 legislators from small voting precincts
2. Election of 69 at-large legislators

The small voting precincts as mentioned in Item 1 are divided equally according to the national population, and one legislator shall be elected from each precinct. The number of minority legislators shall be allocated according to the ratio of the population of the minority groups to total national population. For the at-large legislators mentioned in Item 2, the at-large legislators shall be elected from the candidate list of the political parties wining more than 5% of ballots in election. The quota of at-large legislators for each political party winning more than 5% of ballots shall be determined according to the rate of its vote gain. The quota of legislators for overseas citizens shall be allocated in accordance with the ratio of the overseas citizen population to the total national population.

The difference in the number between male and female candidates nominated by respective political parties shall be no more than three, but it is not limited to those who do not belong to any political party.

Legislator by-election shall be held within two months, and the elected legislators shall succeed to the office within seven days of the confirmation of the election results. The term shall last until the expiry of the original term.

The election of legislators shall be instituted by law.

### Article 15 (President, Vice President of the Legislature and Legislators)

The Legislature has a President and a Vice President, both of whom are elected from legislators.

The partisan caucuses in the Legislature may request the Judicature to interpret the Constitution, the Rights Act, laws and orders.

The partisan caucuses in the Legislature may request the Judicature to revoke the Constitution, the Rights Act, the Order of Martial Law, the Emergency Order, laws and orders in the event that the item with lower priority interferes with the one in higher priority.

Outside the Legislature, legislators are free from responsibility for the opinions and resolutions given inside the Legislature.

Except for the criminal caught in the act, legislators are not allowed to be arrested or detained during the session unless the President of the Legislature approves it.

The increase of legislators' remuneration on a case-by-case basis shall become effective from the next term of office, except in the case of an annual general adjustment.

The number of legislators transferred from government officials shall not be higher than ¼ of total legislators.

Legislators are not allowed to be concurrently serving government officers.

### Article 16 (Sessions and Provisional Sessions of the Legislature)

According to the regulations below, the Legislature shall hold four sessions each year, each of which shall be convened on its own:
1. The first session shall be held between February and the end of March.
2. The second session shall be held between May and the end of June.
3. The third session shall be held between August and the end of September.
4. The fourth session shall be held between November and the end of December. It can be extended as needed.

The Legislature shall hold a provisional session under one of the following circumstances:
1. As requested by the Prime Minister.
2. As requested by more than ¼ of all legislators.

### Chapter 3

### The Judicature

Article 17 (Position, organization and powers of the Judicature)

The Judicature is the highest judicial body of the Country. It has jurisdiction over the following:
1. The constitutional, public affairs, military, administration, criminal affairs, civil litigation and non-contentious cases.
2. Retrial of wrongful imprisonment resulting from the constitutional, public affairs, military and criminal litigation.

The regulations below shall be followed in constitutional, public affairs, military, administrative, criminal affairs, civil litigation and non-contentious cases:

### 1. Constitutional Litigation:

The Constitutional Discipline Act covers charges against public officials, exclusive constitutional accusations, public affairs exclusive accusations, exclusive military accusations, democratic constitutional conventions, and criminal accusations.
In the event that constitutional public officials violate the Constitutional Discipline Act, constitutional litigation shall be filed in accordance with the Constitutional Litigation Act.

### 2. Public Affairs Litigation:

The Public Affairs Discipline Act covers charges against public officials, exclusively public affairs accusations and criminal accusations.
In the event that civil officials violate the Public Affairs Discipline Act, public affairs litigation shall be filed in accordance with the Public Affairs Litigation Act.

### 3. Military Litigation:

The Military Criminal Act covers charges against public officials, exclusively military accusations, and criminal accusations.
In the event that military officers violate the Military Criminal Act, military litigation shall be filed in accordance with the Military Litigation Act.

### 4. Administrative Litigation:

In the event of not seeking the involvement of public law, administrative litigation shall be filed in accordance with the Administrative Litigation Act.

### 5. Criminal Litigation:

In the event that personnel not occupying a public post violate the Criminal Code, criminal litigation shall be filed in accordance with the Code of Criminal Procedure.

### 6. Civil Litigation:

In the event of not seeking the involvement of private law, civil litigation shall be filed in accordance with the Code of Civil Procedure.

### 7. Non-Contentious Cases:

In the event of not seeking the exercise of non-contentious rights, the verdict for non-contentious cases shall be petitioned in accordance with the Non-Contentious Incidence Act.

The priority of the laws or orders promulgated by the Country follows the order of the Constitution, the Rights Act, the Order of Martial Law, Emergency Order, laws and orders, in which the item with lower priority shall be invalidated and revoked by the Judicature if it interferes with the one having higher priority.

The Judicature is entitled to interpret the Constitution, the Rights Act, laws and orders.

The Judicature shall decree judicial orders by law, and is entitled to correct the trial conducted by respective litigation courts and the investigation conducted by respective litigation prosecution and police agencies.

Following the Partisan Act, the Judicature shall divide the political parties wining more than 5% of ballots in the Prime Minister Election into more than two political parties or combine them to be less than five political parties.

Following the negotiation procedure regulated by the Partisan Act, the Judicature shall maintain the number of the legislators in either Prime Minister Parties or non-Prime Minister Parties at less than ⅔ of all legislators.

Following the completion of the examination of Central Government's general final accounts, the Judicature shall prepare the examination report and send to the Legislature for review, while also sending a copy to the relevant prosecution agencies under the Executive Government and the Judicature.

In the event that the position of Prime Minister is vacant or the Prime Minister is incapable of attending business, the Judicature shall proclaim the eligible candidates for the post of Prime Minister or Acting Prime Minister, and under special conditions, have the next one in the ex officio candidate list succeed to the office.

Following the resignation of the First Deputy Prime Minister who succeeds the previous Prime Minister, the Judicature shall announce the eligible candidates for the temporary alternatives of chief and deputy chief officers of respective agencies, and, under special conditions, have the first ex officio alternative candidate on the list temporarily succeed to the office.

In the event that the Prime Minister leaves the Country in peace time or is involved in constitutional litigation resulting in temporary post suspension, the Judicature shall announce the eligible candidates for the post of temporary Acting Prime Minister, and under special circumstances, have the first ex officio alternative candidate on the list temporarily succeed to the office. In the event that the Prime Minister returns to the Country or is reinstated due to a non-guilty verdict, the Judicature shall announce the dismissal of the temporary Acting Prime Minister.

The organization of the Judicature and its different levels of courts shall be instituted by law.

### Article 18 (The Council of the Judicature)

The Council of the Judicature in the Judicature consists of Grand Justices, the chief auditor, court chief officers, the chief prosecutors, and the police general. The President of the Judicature shall preside over the Council.

Grand Justices, court chief officers, the chief prosecutors and the police general shall submit the litigation procedure bill, Judicature organization bill, court organization bill, judicial personnel bill, audit personnel bill and other important items, which shall be submitted to the Legislature, to the Council of the Judicature for resolution.

Grand Justices, court chief officers, the chief prosecutors and the police general shall propose honor awarding cases which shall be submitted to the Executive Government to the Council of the Judicature for resolution.

Chief officers of respective supreme courts of litigation shall propose wrongful imprisonment cases, amnesty cases and reinstatement cases to be submitted to the Executive Government to the Council of the Judicature for resolution.

The organization of the Council of the Judicature and its council procedure shall be instituted by law.

### Article 19 (The Grand Justices Council)

The Grand Justices Council in the Judicature is in charge of exercising the powers of the Judicature, in which it may directly conduct trial of national material litigation cases. It is made up of nine Grand Justices, including one President and one Vice President. The Grand Justices are nominated by the Executive Government and approved and appointed by the Legislature. The term is eight years which shall be individually calculated regardless of the sequence of the year, and renewal is not allowed. After the expiry of the term, they shall be transferred and given a lifelong post of judge or prosecutor.

The Judicature is entitled to resolve that the Prime Minister be temporarily exempt from co-signature restriction.

The Judicature may resolve to add the charge of constitutional discipline against the Prime Minister in situations other than internal riots and external intrusion, and the charge shall not be announced before the Prime Minister is given a verdict which is more than the imprisonment sentence.

The Judicature shall nominate the chief auditor for the Legislature to approve and appoint. The term is six years and renewal is not allowed.

The Judicature shall nominate chief officers of the constitutional supreme court, public affairs supreme court, administration supreme court, military supreme court, criminal supreme court and civil supreme court for the Judicature to approve and appoint. The term is six years and renewal is not allowed.

The Judicature shall nominate the constitutional prosecutor general, public affairs prosecutor general and military prosecutor general for the Legislature to approve and appoint. The term is six years, and renewal is not allowed.

The Judicature shall nominate lifelong judges and prosecutors for the Legislature to approve and appoint.

The Judicature shall nominate judges and prosecutors of litigation supreme courts who concurrently serve as wrongful imprisonment officers for the Legislature to approve and appoint. The term is three years which shall be individually calculated regardless of the sequence of the year, and renewal is not allowed.

The Judicature shall nominate judging officers of the Policy Council in the Executive Government for the Legislature to approve and appoint. The term is six years which shall be individually calculated regardless of the sequences of the year, and there is no limitation to renewal frequency.

The organization of the Grand Justices Council and its council procedure shall be instituted by law.

### Article 20 (The Judicial Order Council)

The Judicial Order Council in the Judicature is an advisory agency for Grand Justices to determine the promulgation, modification and revocation of judicial orders. The Council shall be attended by Grand Justices, lifelong judges, lifelong prosecutors, chief officers and prosecutor generals of litigation supreme courts, the police general and the relevant personnel designated by Grand Justices. The President of the Judicature shall preside over the Council.

In the event that the verdict of constitutional, public affairs, administrative, military, criminal and civil litigation leads to improper simulation resulting in a chain effect, the judge or prosecutor shall propose a judicial order for trial correction.

In the event that the evidence acquisition investigation procedure to validate evidence is denied by the judge during the trial period of constitutional, public affairs, military or criminal litigation, the judge or prosecutor shall propose a judicial order for investigation correction.

With the judicial order, special amnesty and reinstatement may be proposed for the finalized or un-finalized termers in applicable cases of which litigation trial has been submitted to the Council of the Judicature for resolution.

With the judicial order, effective evidence may be deemed invalid for litigation cases under investigation period or yet to finish trial.

The trial correction judicial order is organized as the Trial Case Act, and investigation correction judicial order is organized as the Investigation Case Act. It is mandatory that judicial personnel follow these Acts.

The organizational procedure of the Trial Case Act and the Investigation Case Act shall be instituted by law.

The organization of the Judicial Order Council and its council procedure shall be instituted by law.

### Article 21 (The Audit Council)

The Audit Council in the Judicature consists of a chief auditor, a deputy chief auditor and several audit officers. It is in charge of financial audits of the Government and its affiliated agencies. It is also an advisory organ for grand justices in determining the guidelines for investigating corruption amongst constitutional public officers and general public officers, bribe acceptance or ill-gotten benefits.

The Audit Council shall be attended by Grand Justices, the chief auditor, the deputy chief auditor, the constitutional prosecutor general, the public affairs prosecutor general, and the military prosecutor general. The President of the Judicature shall preside over the Council.

Audit officials include the chief auditor, the deputy chief auditor, audit officers, and personnel of auditing, accounting and statistics.

Audit officials shall be independent of all political parties and, by law, exercise auditing rights independently without any interference.

Unless being subject to constitutional punishment or an interdiction declaration, the chief auditor, the deputy chief auditor and audit officers cannot be dismissed; or be suspended from duties, transferred or given salary deduction, unless otherwise stated in law.

Unless being subject to public affairs punishment or an interdiction declaration, the personnel of audit, accounting and statistics cannot be dismissed; or be suspended from duties, transferred or given salary deduction, unless otherwise stated in law.

The organization of the Audit Council and its council procedure shall be instituted by law.

### Article 22 (Judges)

Judges include Grand Justices, constitutional judges, public affairs judges, administrative judges, military judges, criminal judges and civil judges.

Lawyers having at least three years of practice and more than 12 times of court attendance are eligible to be approved and appointed by the Judicature as a criminal or civil judge in accordance with the Judge Election Act

After being evaluated by the Judicature, judges may be transferred to serve as a constitutional judge, administrative judge, military judge, criminal judge, or civil judge.

Judges shall be independent of all political parties and, by law, conduct trial, determine evidence as irrefutable, withdraw illegal litigation proceeding, and. in the event that the evidence is incomplete or additional investigation is required, instruct prosecutors to investigate the litigation-related evidence without any interference.

Unless being subject to constitutional punishment or an interdiction declaration, Grand Justices, constitutional judges, public affairs judges, administrative judges and military judges cannot be dismissed; or be suspended from duties, transferred or given salary deductions, unless otherwise stated in law.

Unless being subject to public affairs punishment or an interdiction declaration, criminal judges and civil judges cannot be dismissed; or be suspended from duties, transferred or given salary deductions, unless otherwise stated in law.

The judge concurrently serving as a wrongful imprisonment officer shall have the ability to independently judge the evidence by law. In the event that the evidence is incomplete or additional investigation is required, the judge may instruct the prosecutor, currently the wrongful imprisonment officer, to investigate the wrongful imprisonment-related evidence without any interference.

When exercising their powers as a judge, grand justices are entitled to command judicial police officers and order judicial police actions.

### Article 23 (Prosecutors)

Prosecutors include Grand Justices, constitutional prosecutors, public affairs prosecutors, military prosecutors and criminal prosecutors.

Lawyers having at least three years of practice and more than 12 times of court attendance are eligible to be approved and appointed by the Judicature as criminal prosecutors in accordance with the Judge Election Act.

After being evaluated by the Judicature, prosecutors may be transferred to serve as a constitutional prosecutor, public affairs prosecutor, administrative prosecutor, military prosecutor or criminal prosecutor.

Administrative litigation requiring administrative execution shall be conducted by public affairs prosecutors, whereas civil litigation requiring compulsory execution shall be conducted by criminal prosecutors.

Prosecutors shall be independent of all political parties and, by law, conduct searches and investigation, file public prosecution, execute public prosecution, assist private prosecution, take on private prosecution and command the implementation of criminal judgment. For any litigation-related evidence, prosecutors may apply for judiciary interpretation of the Constitution, the Rights Act, laws and orders, give oral arguments, arrange medical and scientific appraisals and provide reliability evaluations. At the same time, during the trial period they may also directly request the supreme court of the litigation to revoke the case, in which the criminal proceeding in the current trial court will have no interference.

Without agreement from the chief prosecutor of the current trial court, interpretation of the preceding Constitution, Rights act, laws and orders is not allowed to be applied, or the request for the revocation of the illegal litigation proceeding is not allowed.

Unless being subject to constitutional punishment or an interdiction declaration, Grand Justices, constitutional prosecutors, public affairs prosecutors, and military prosecutors cannot be dismissed; or be suspended from duties, transferred or given salary deductions, unless otherwise stated in law.

Unless being subject to public affairs punishment or an interdiction declaration, criminal prosecutors cannot be dismissed; or be suspended form duties, transferred or given salary deduction, unless otherwise stated in law.

The prosecutor concurrently the wrongful imprisonment officer may inspect the prison and proceed with the prisoner recording by law. Also, after obtaining wrongful imprisonment-related evidence, the prosecutor shall submit it to the supreme court of the prison's original litigation for trial without interference.

When conducting investigation or carrying out implementation, prosecutors are entitled to command and order judicial police officers to act.

When it is necessary, the preceding prosecutors may request the police agency to dispatch armed police and are entitled to command and order armed police officers to act.

In the case that Grand Justices exercise their prosecution powers, instead of the judge who files the public prosecution, the trial agency shall be the Grand Justices Council.

### Article 24 (Lawyers)

Lawyers are categorized as either national public lawyers or national registration lawyers.

Those who passed the national civil service examination for public lawyers and are approved by the Judicature may serve as a public lawyer.

Those who passed the national registration examination for lawyers and are approved by the Judicature may serve as a national registration lawyer.

On behalf of the litigant, a lawyer may, in regard to any litigation-related evidence, apply for judiciary interpretation of the Constitution, the Rights Act, laws and orders; request review of dossiers; apply for search and investigation; give oral arguments; arrange medical and scientific appraisals; provide reliability evaluations; and also directly request the supreme court of the litigation, during the trial period, to revoke the case, where the criminal proceeding in the current trial court will have no interference.

Without the approval of the director of the current trial court or national registration lawyer association, the application for the interpretation of the Constitution, the Rights Act, laws and orders is not allowed to be filed by the national public lawyers or national registration lawyers, respectively.

Unless being subject to criminal and lawyer punishment or an interdiction declaration, a lawyer's credentials are not allowed to be revoked, and lawyer's legal practice is also not allowed to be suspended.

### Article 25 (Police)

Police are categorized as armed police or judicial police.

Those who graduate from the armed police specialty of police school are eligible to be approved and appointed by the Judicature as the armed police in accordance with the Armed Police Election Act. The term is for ten years which shall be individually calculated regardless of the sequence of the year, and renewal is not allowed. After the expiry of the term, they shall be transferred to be the judicial police.

Based on the Judicial Police Election Act, those who graduate from police school or military police school are eligible to be selected as the judicial police after being approved and appointed by the Judicature.

Based on the attributes of the posts, judicial police are divided into criminal police, public security police and specialty police.

Police shall be independent of all political parties and, by law, assist prosecutors in crime investigation, searches, seizures, detention and arrest without interference.

Unless being subject to constitutional punishment or an interdiction declaration, the police general, armed police officers and judicial police officers cannot be dismissed; or be suspended from duties, transferred or given salary deductions, unless otherwise stated in law.

Unless being subject to public affairs punishment or an interdiction declaration, police officers cannot be dismissed; or be suspended from duties, transferred or given salary deductions, unless otherwise stated in law.

The priority in police investigation of crime cases is in the sequence of armed police, criminal police, public security police and specialty police.

As authorized by the police general, armed police may deploy armed aircraft.

As authorized by the police general or armed police officers, armed police may carry unconventional weapons.

Without being authorized, the preceding armed police are regarded as criminal police who shall wear conventional weapons.

Public security police shall wear defensive weapons and have conventional weapons with them on patrol.

The control of police's weapons shall be instituted law.

### APPENDIX 1

### Organization of the Executive Government, Legislature and Judicature

### Chapter 1

### The Executive Government

### Council of the Executive Government

### Financial and Economic Council

### National Construction Council

### National Security Council

### Crime Prevention Council

### Policy Council (The Lower Chamber)

### Ministry of Internal Affairs (Armed and Judicial Police)

### Ministry of Foreign Affairs

### Ministry of National Defense (Military Intelligence Bureau)

### Ministry of Finance (Urgency Provision Fund)

### Ministry of Economic Affairs (Price Stabilization Fund)

### Ministry of Agriculture (Grains Reserve Fund)

### Ministry of Health (Medical Relief Fund)

Ministry of Education (all levels of schools and graduate institutes)

### Ministry of Construction

### Ministry of Justice (Criminal Prosecutor)

### Ministry of Transportation and Communications

Ministry of Civil Examination (for civil and military officers and registration examinations)

### Ministry of Human Resources

### Department of Environmental Protection

### Department of Tourism Culture

### Government Information Bureau

### Comptroller Bureau

### Central Intelligence Bureau

### Central Personnel Administration Bureau

### Chapter 2

### The Legislature

### Council of the Legislature (The Upper Chamber)

Various commissions

### Ministry of Administration

### Central Personnel Administration Bureau

### Chapter 3

### The Judicature

### Council of the Judicature (The Judicature)

### Grand Justices Council (Grand Justices)

### Council of Judicial Orders

### Audit Council

### Supreme Constitutional Court

### High Constitutional Court

### Supreme Public Affairs Court

### High Public Affairs Court

### Supreme Administrative Court

### High Administrative Court

### Supreme Military Court

### High Military Court

### Military Court

### Supreme Criminal Court

### High Criminal Court

### Criminal Court

### Supreme Civil Court

### High Civil Court

### Civil Court

### Central Personnel Administration Bureau

### Chapter 4

### Independent Organizations

### The Central Bank (Exchange Stabilization Fund)

### Central Election Commission

### National Communications Commission

### APPENDIX 2

### The Institution of the Core Regulations of the System

### Chapter 1

### The Executive Government

### Organic Act of the Executive Government

### Organic Act of the Council of the Executive Government

### Organic Act of the Financial and Economic Council

### Organic Act of the National Construction Council

### Organic Act of the National Security Council

### Organic Act of the Crime Prevention Council

### Organic Act of the Policy Council

### Procedure Act of the Executive Government Council

### Procedure Act of the Financial and Economic Council

### Procedure Act of the National Construction Council

### Procedure Act of the National Security Council

### Procedure Act of the Crime Prevention Council

### Procedure Act of the Policy Council

### Military Order Act

### Administrative Order Act

### Martial Law

### Emergency Order Act

### Constitutional Public Official Act

### General Public Official Act

### Personnel Recommendation, Appointment and Dismissal Act

### Amnesty Act

### Honor Act

### War Declaration and Peace Making Act

### Budget Act

### Budget Settlement Act

### National Civil Service Examination Act

### National Military Service Examination Act

### National Registration Examination Act

### Constitutional Discipline Act

### Public Affairs Discipline Act

### Administrative Discipline Act

### Armed Forces Criminal Act (Army, Navy and Air Force Criminal Act)

### Criminal Act

### Civil Act

### Armed Forces Weapon Control Act

### Police Weapon Control Act

### Premier Election Act

### Referendum Act

### Chapter 2

### The Legislature

### Organic Act of the Legislature

### Commission Organic Law of the Legislature

### Council Procedure Act of the Legislature

### Commission Procedure Act of the Legislature

### Legislator Election Act

### Chapter 3

### The Judicature

### Organic Act of the Judicature

### Court Organic Act

### Council Organic Act of the Judicature

### Organic Act of the Grand Justices Council

### Organic Act of the Judicial Order Council

### Organic Act of the Audit Council

### Council Procedure Act of the Judicature

### Procedure Act of the Grand Justices Council

### Procedure Act of the Judicial Order Council

### Procedure Act of the Audit Council

### Judicial Order Act

### Audit Act

### Trial Case Act

### Investigation Case Act

### Constitutional Litigation Act

### Public Affairs Litigation Act

### Administrative Litigation Act

### Military Litigation Act

### Criminal Procedure Act

### Civil Procedure Act

### Judging Officer Election Act

### Judge Election Act

### Armed Police Election Act

### Judicial Police Election Act

### APPENDIX 3

### Definitions

| | |
|---|---|
| The Constitution | A nation, autonomous district, region or political organization |
| | constituted according to people, territory, sovereignty and |
| | government shall replace the term of the “Constitution” |
| | mentioned in the articles with the highest legal name of the |
| | autonomous district or region. |
| Rights Act | Same as the Constitution, it belongs to the highest law, and |
| | ranks only second to the Constitution. It defines the range of |
| | territory and rights exercise range, and effective years of |
| | people's rights, obligations and taxes, and the policy of |
| | industry protection. |
| Nation/Country | A political organization constituted by people, territory, |
| | sovereignty and government. The term of “nation” or “country” |
| | mentioned in the articles shall be replaced with the name of the |
| | nation, autonomous district, region or political organization. |
| Prime Minister | In general, it refers to one who regularly participates in partisan |
| | activities. |
| Deputy Prime Minister | In general, it refers to one who regularly participates in partisan |
| | activities. |
| Cabinet Officer | One who regularly or irregularly participates in partisan |
| | activities. |
| Civil and Military Officer | One who passes the national civil or military service |
| | examination. |
| Judging Officer | A retired person from all walks of life who irregularly |
| | participates in partisan activities. |
| Policy Council Deputy | A national constitutional civil officer or national public affairs |
| | civil officer. |
| Policy Commissioner | A person from all walks of life who regularly or irregularly |
| | participates in partisan activities. The number of those who |
| | regularly participate in partisan activities shall not be over ⅓ |
| | of the total nominated number. |
| Secretary General of the | A general. |
| National Security Council | |
| Deputy Secretary General | A general or lieutenant general. |
| of the National Security | |
| Council | |
| Intelligence Officer of the | A lieutenant general, major general or brigadier general. |
| National Security Council | |
| Legislator | A person from all walks of life who regularly participates in |
| | partisan activities. |
| Grand Justice, Justice of | A judge, prosecutor or law researcher. |
| the Constitutional Court | |
| Chief Auditor of the Audit | A national constitutional civil officer, national public affairs |
| Council | civil officer, or accounting and financial researcher. |
| Deputy Chief Auditor of the | A national public affairs civil officer. |
| Audit Council | |
| Audit Officer of the Audit | A national public affairs civil officer. |
| Council | |
| Constitutional Judge | A public affairs, military, administrative, criminal or civil |
| | judge. |
| Public Affairs Judge | A constitutional, military, administrative, criminal or civil |
| | judge. |
| Administrative Judge | A constitutional, public affairs, military, criminal or civil judge. |
| Military Judge | A constitutional, public affairs, administrative or criminal |
| | judge. |
| Criminal Judge and Civil | A lawyer having at least three years of practice and more than |
| Judge | 12 times of court attendance, and having passed the judge |
| | election examination, as well as criminal judge examination |
| | or civil judge examination. |
| Constitutional Prosecutor | A public affairs, military or criminal prosecutor. |
| Public Affairs Prosecutor | A constitutional, military or criminal prosecutor. |
| Military Prosecutor | A constitutional, public affairs or criminal prosecutor. |
| Criminal Prosecutor | A lawyer having at least three years of practice and more than |
| | 12 times of court attendance, and having passed the judge |
| | election examination and criminal prosecutor examination. |
| Lawyer | One who passes the national civil service examination for |
| | public lawyers is eligible to serve as a national public lawyer, |
| | whereas one who passes the national registration examination |
| | for lawyers is eligible to serve as a national registration lawyer. |
| Armed Police | One who graduates from the armed police specialty of police |
| | school is eligible to be elected as an armed police officer in |
| | accordance with the Armed Police Election Act. |
| Judicial Police | One who graduates from police school and military police |
| (Judicial Police Officer) | school is eligible to be elected as a judicial police officer in |
| | accordance with the Judicial Police Election Act. |

1. The inventor gets a 2% royalty of the general budget of the central government.

2. The users endow a 6% royalty to medical, environmental, and charity organizations with anonymity; if contributors disclose themselves to the public, the subscription is invalid.

3. The master budget of central government is the country, autonomous region, area or financial organization of the political organization, to the whole country. Or getting the whole autonomous region, area or political organization. The people, the meaning of total taxation income levying taxes according to the law. Country, autonomous region, area or political organization where this patent is licensed, with the government delegating power to the lower levels to secondary government and administration, so that the governments of secondary government and administration have power to levy tax on people of its area under one's jurisdiction, the calculation of the money of right is a government with secondary governments and administration, or the tax revenue total value that all administrative departments with taxation power levy taxes, as the master budget of central government referred to of this patent, and must pay the money of right according to the regulations of the first, two items. This regulation is to avoid the country, autonomous region, area or political organization, by the transfer of taxation power intentionally, make the empty grade of central government melt, thus evade the payment mechanism of money of this patent right.

4. This patent has front and back clauses implicative of each other, executive power, legislative power and judicial power check and balance each other, and there are inalienable characteristics.
